(19) United States
(12) Patent Application Publication
(10) Pub. No.: US 2026/0085600 A1
(43) Pub. Date: Mar. 26, 2026

(54) TRAINING OF MACHINE LEARNING MODELS FOR WELL TARGET RECOMMENDATION

(71) Applicant: SCHLUMBERGER TECHNOLOGY CORPORATION, Sugar Land, TX (US)

(72) Inventors: Tobi ADEYEMI, Abington (GB); Philipp LANG, Abington (GB)

(21) Appl. No.: 19/112,655

(22) PCT Filed: Sep. 18, 2023
(86) PCT No.: PCT/US2023/033033

§ 371 Date: Mar. 18, 2025

Related U.S. Application Data
(60) Provisional application No. 63/376,118, filed on Sep. 19, 2022.

(51) Int. Cl. E21B 43/30; G06F 30/27; G06F 111/04; G06F 111/08; G06F 113/08; G06F 119/14

(52) U.S. Cl. CPC E21B 43/30; G06F 30/27; E21B 2200/20; E21B 2200/22; G06F 2111/04; G06F 2111/08; G06F 2113/08; G06F 2119/14

(57) ABSTRACT

Disclosed are methods, systems, and computer programs for placing one or more optimal infill well locations within a reservoir. The methods include: generating a first multi-dimensional reservoir model of a first reservoir that is parameterized; assigning well placement data to the first reservoir model to generate a simulation model; applying a stochastic optimization process in a first simulation on the simulation model; determining infill well locations data based on the first simulation; configuring a second multi-dimensional reservoir model based on the infill well locations data; and generating using the second multi-dimensional reservoir model, one or more of: pressure delta data for one or more infill locations associated with a second reservoir, and a simulation opportunity index indicating reservoir properties for the one or more infill locations associated with the second reservoir.

### CROSS-REFERENCE TO RELATED APPLICATIONS

This application claims priority to US Provisional Application No. 63/376,118, filed on Sep. 19, 2022, titled “Training Of Machine Learning Models For Well Target Recommendation,” which is incorporated herein by reference in its entirety for all purposes.

### BACKGROUND

Determining an optimal location for an infill well in a mature reservoir is a vital component of the reservoir operation workflow. At present, the optimal location for an infill well may be found using an optimization signal processing process. However, most optimization signal processing processes for locating the optimal location for an infill well are computationally-intensive and time-consuming as they require several calls to a physics-based simulator. Executing multiple calls to the physics-based simulator may often be infeasible when dealing with an ensemble of models associated with the infill well.

### SUMMARY

Disclosed are methods, systems, and computer programs for placing one or more optimal infill well locations within a reservoir. According to an embodiment, a method for placing one or more optimal infill well locations within a reservoir comprises: generating a first multi-dimensional reservoir model of a first reservoir that is parameterized; assigning one or more numbers of well placements to the first reservoir model to generate a simulation model; applying a stochastic optimization process in a first simulation on the simulation model; determining one or more infill well locations based on the first simulation, the one or more infill well location satisfying a constraint of maintaining a physical distance from existing wells associated with the first reservoir that results in at least a percentage threshold amount increase in cumulative production relative to the production obtained without the one or more infill well locations for the total operation period of the first reservoir. In response to determining the one or more infill well locations based on the first simulation, the methods further include: generating training data for configuring a second multi-dimensional reservoir model; and generating using the second multi-dimensional reservoir model, one or more of: a pressure delta for one or more infill locations associated with a second reservoir, and a simulation opportunity index indicating reservoir properties for the one or more infill locations associated with the second reservoir.

In another embodiment, a system and a computer program can include or execute the method described above. These and other implementations may each optionally include one or more of the following features. For example, the first multi-dimensional reservoir model is based on a plurality of reservoirs including the first reservoir. Furthermore, the first multi-dimensional reservoir model of the first reservoir is parameterized using one or more of: data associated with a number of wells of the first reservoir; data associated with a number of grid cells of the first reservoir; data associated with an average permeability of the first reservoir; or data associated with a production duration history of the reservoir.

According to some embodiments, the number of well placements include: one or more producer wells indicating one or more wells associated with the first reservoir from which fluid is produced; or one or more injector wells indicating one or more wells associated with the first reservoir into which fluid is injected. Moreover, the stochastic optimization process includes one or more of: dynamically moving a target well around a plurality of locations associated with the first reservoir; and generating production data indicative of a predicted fluid production of the target well at the plurality of locations of the first reservoir. In addition, generating using the second multi-dimensional reservoir model, comprises one or more of: determining a pressure delta for one or more infill locations associated with a second reservoir; and generating a simulation opportunity index indicating reservoir properties for the one or more infill locations associated with the second reservoir is in real-time or near real-time. According to some embodiments, generating using the second multi-dimensional reservoir model, comprises one or more of: determining a pressure delta for one or more infill locations associated with a second reservoir; and a simulation opportunity index indicating reservoir properties for the one or more infill locations associated with the second reservoir. Moreover, the disclosed process may further include initiating rendering of a multi-dimensional visualization including visual elements of at least the pressure delta or the simulation opportunity index such that the multi-dimensional visualization provides a map indicating one or more optimal infill well locations associated with the second reservoir.

It is appreciated that the present disclosure uses a machine learning solution to enable fast (e.g., real-time or near real-time) identification of infill targets/wells in mature reservoirs based on an ensemble of models associated with infill wells. The methods and systems use a synergistic combination of mathematical optimization and machine learning techniques. In one embodiment, a multi-dimensional (e.g., a 3-dimensional) image segmentation model is applied to identifying the optimal locations of the infill wells using reservoir simulation property fields of the infill wells as inputs. The multi-dimensional image segmentation model may provide fast (e.g., real-time or near real-time) inference with its output being likely well target regions in the reservoir.

In one embodiment, the methods disclosed involve an initial step of the machine learning workflow that focuses on generating training data. In particular, simulation cases with a random number of initial well placements including a variable number of producer wells and injector wells may be generated during the initial step. The reservoir model may then be simulated for a variable number of years using a reservoir simulator (e.g., Eclipse, Intersect, etc.).

Following the initial simulation run, a stochastic gradient free optimization process may be employed to determine an optimal (e.g., the best) vertical infill well location that maximizes cumulative oil production for additional years of operating the reservoir to which the infill well is associated. The addition of the infill well to the reservoir, according to some implementations, may be based on a percentage constraint (e.g., at least 5%, or at least 10%, or at least 15%, or at least 20%) that indicates an increase in fluid production from the reservoir based on the infill well relative to fluid production from other (e.g., initial) wells associated with the reservoir.

In some embodiments, the reservoir pressure response at an initial reservoir state and a time step at which the initial well is placed and also the opportunity index at said time step may both be used as input features into the machine learning model. The infill well location as determined by the optimization process may be used as a label. The disclosed technology allows for the development of tools that learn or otherwise generate a function that maps the reservoir property input fields of a given reservoir to labels which correspond to optimal infill well location associated with the given reservoir.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 shows an exemplary high-level flowchart for executing one or more processes provided by this disclosure.

FIG. 2 shows a cross-sectional view of a resource site for which the process of FIG. 1 may be executed.

FIG. 3 shows a networked system illustrating a communicative coupling of devices or systems associated with the resource site of FIG. 2.

FIGS. 4-6 provide exemplary flowcharts for determining an optimal infill well location associated with a reservoir.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring natural resources such as oil, gas, water well industries, and other mineral exploration operations. More specifically, the systems and methods presently disclosed may be applicable to exploring resources such as oil, natural gas, water, and Salar brines.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, or resource data, etc., is sufficiently accurate.

### High-Level Flowchart

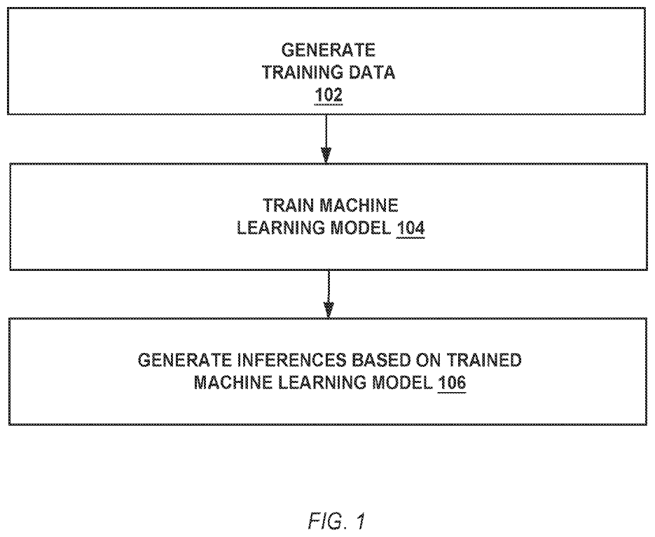

The disclosed technology, according to some implementations, includes the processing stages outlined in FIG. 1. At block 102, the method includes generating training data which is used to train, customize, or configure at block 104 a machine learning model associated with a first reservoir. At block 106, an inference engine/machine learning engine may generate inferences (e.g., machine learning inferences) using the machine learning model and based on data associated with a second reservoir that may be separate from the first reservoir. The inferences generated by the machine learning engine may include optimal infill well locations associated with the second reservoir. Such inferences may be based on a multi-dimensional (3-dimensional) reservoir grid or visualization with indicators pointing to identified one or more optimal infill well locations associated with the disclosed process. It is appreciated that an infill well location may include a location or section associated with the first or second reservoir to which an additional well may be fluidly coupled (e.g., drilled).

### Resource Site

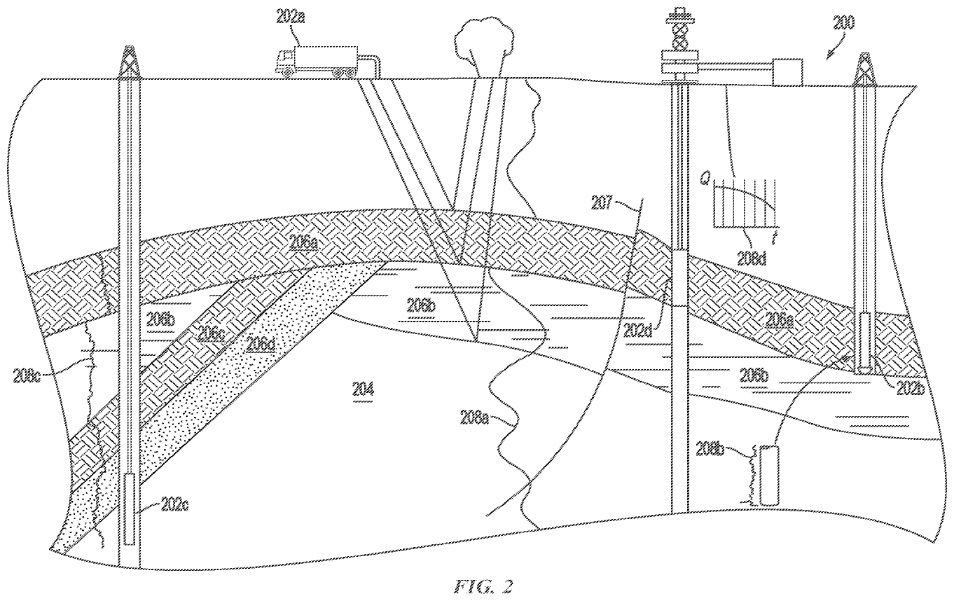

FIG. 2 shows a cross-sectional view of an exemplary resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, etc. According to one embodiment, various measurement tools capable of sensing one or more parameters such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and collect data for executing the process of FIG. 1.

Part, or all, of the resource site 200 may be on land, on water, or below water. In addition, while a resource site 200 is depicted, the technology described herein may be used with any combination of one or more resource sites (e.g., multiple oil fields or multiple wellsites, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the oil field 200 may contain a variety of geological structures and/or formations, sometimes having extreme complexity. In some locations of a given geological structure, for example below a water line relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. The data collected from various sources at the resource site 200 may be processed and/or evaluated and/or used as training data, and or used to generate high resolution result sets for characterizing a resource at the resource site, and/or used for generating resource models, etc. In one embodiment, the data collected by one or more sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., # of years of production) of the first reservoir or second, etc.

Data acquisition tool 202a is illustrated as a measurement truck, which may include devices or sensors that take measurements of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the oil field 200 to collect data relating to various oil field operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the formation, wellbore, formation fluid/gas, wellbore fluid, gas/oil/water included in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or sensors may be used to characterize, or otherwise generate one or more parameter values for a high-resolution result set used to, for example, generate a resource model (e.g., well model, reservoir model, etc.). In other embodiments, test data or synthetic data may also be used in developing the resource model via one or more simulations such as those discussed in association with the flowcharts presented herein.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of Schlumberger); induction sensors such as Rt Scanner™ (mark of Schlumberger), multifrequency dielectric dispersion sensor such as Dielectric Scanner™ (mark of Schlumberger); acoustic tools including sonic sensors, such as Sonic Scanner™ (mark of Schlumberger) or ultrasonic sensors, such as pulse-echo sensor as in UBI™ or PowerEcho™ (marks of Schlumberger) or flexural sensors PowerFlex™ (mark of Schlumberger); nuclear sensors such as Litho Scanner™ (mark of Schlumberger) or nuclear magnetic resonance sensors; fluid sampling tools including fluid analysis sensors such as InSitu Fluid Analyzer™ (mark of Schlumberger); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data associated with the resource site 200 and/or sites similar to the resource site 200, user inputs, information (e.g., economic information) associated with the resource site 200 and/or sites similar to the resource site 200, synthetic data associated with the resource site, and/or other measurement data and other parameters of interest. Similar measurements may also be used to measure changes in formation aspects over time.

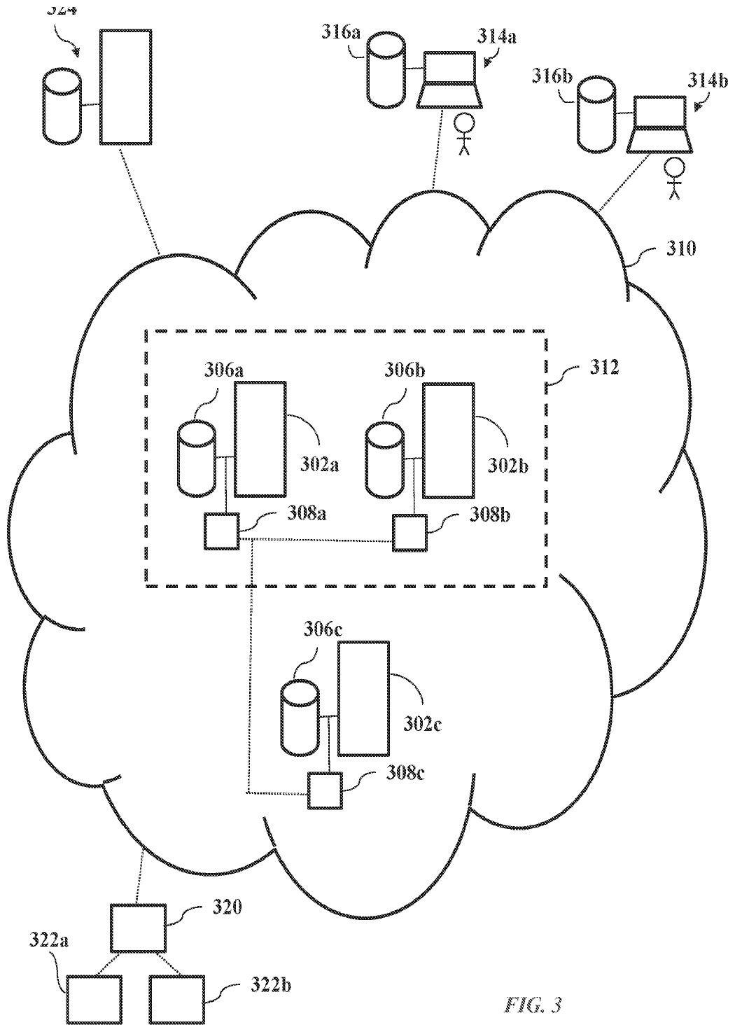

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data and/or synthetic data and/or other inputs for further analysis or for modeling purposes to optimize production processes at the oil field 200. In one embodiment, the data is stored in separate databases, or combined into a single database.

### High-Level Networked System

FIG. 3 shows a high-level networked system diagram illustrating a communicative coupling of devices or systems associated with the resource site 200. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the oil field 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more oil fields 200 having, for example, a set of terminals 320, each including at least a processor, a memory, and a communication device for communicating with other devices communicatively coupled to the cloud-computing platform 310. The resource site 200 may also have one or more sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the one or more sensors/sensor interfaces 322a and 322b may be processed to generate one or more resource models (e.g., reservoir models) or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more signal processing and/or application specific integrated circuits.

Further, the steps in the flowcharts described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 1 as well as the flowcharts below may be executed using a signal processing engine or a data processing engine stored in memory 306a, 306b, or 306c such that the signal processing engine or data processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs include instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Training Data Generation

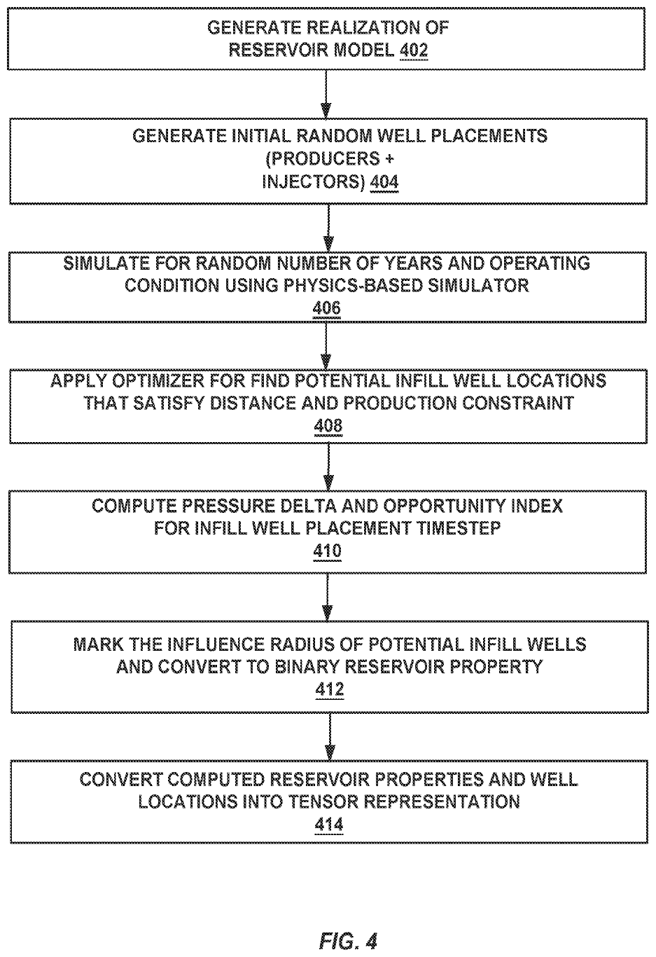

FIG. 4 shows a flowchart for generating training data according to one embodiment of this disclosure. At block 402, a realization of the reservoir model may be generated for a first reservoir. The reservoir model, in some implementations, includes a template or framework (e.g., 3-dimensional object associated with a first reservoir) that has a plurality of parameters such as data associated with the number of wells fluidly coupled to the first reservoir, data associated with a number of grid cells associated with the first reservoir, data associated with an average permeability of the first reservoir, data associated with the production duration history (e.g., # of years of production) of the first reservoir, etc. The flowchart proceeds to block 404 where random well placements including a variable number of producers (e.g., producer wells) and injectors (e.g., injector wells) in a reservoir simulation model are generated. According to one embodiment, the producers include one or more wells associated with the first reservoir from which fluid (e.g., crude oil, Salar brine, aquifers, etc.) can be produced or otherwise extracted. Similarly, the injectors may include one or more wells associated with the first reservoir into which fluid can be injected or otherwise pumped. In some embodiments, generating the number of random well placements includes assigning a first number or a second number or a third number, etc., indicating a first number of producers and injectors, or a second number of injectors and producers, or a third number of producers and injectors based on the production data associated with the first reservoir. According to some embodiments, generating the random number of well placements includes assigning, ascribing, or parameterizing, or configuring the variable number of producers and injectors in the reservoir model with numerical values. This reservoir model is thereafter run, at block 406, in a simulation for a predefined amount of time (e.g., years, months, weeks, days, etc.) using a physics-based simulator (e.g., Eclipse, Intersect, etc.). Following the initial simulation run, a stochastic gradient-free optimization process may be used, at block 408, to determine an optimal vertical infill well location that maximizes the cumulative oil production in the reservoir (e.g., the first reservoir) for additional years (e.g., 3-10 years) of production. According to some embodiments, the stochastic gradient-free optimization process involves dynamically moving an optimal target well around the reservoir (e.g., a first location of the reservoir, second location of the reservoir, third location of the reservoir, n-th location of the reservoir) and generating production data indicative of a predicted production (e.g. fluid production) of the target well at the specific location of the reservoir. The optimal infill well location, according to some implementations, satisfies a constraint (e.g., percentage constraint) associated with maintaining a physically meaningful distance from existing wells associated with the first reservoir that results in at least a percentage threshold amount (e.g., 10%-30%) increases in cumulative production relative to the production obtained without the infill well location for the total reservoir operation period. All locations of the reservoir evaluated by the optimizer that satisfy the threshold amount constraint may be considered as potential infill well locations, according to some embodiments.

Following the identification of the potential optimal infill well locations using the optimization process and based on the simulation model, a pressure delta and a simulation opportunity index of the reservoir model at the time-step at which the infill well is added are computed or otherwise generated at block 410. The pressure delta may be computed as a normalized ratio between the reservoir pressure (e.g., reservoir pressure associated with the simulation model) at the initial reservoir state and the reservoir state at which the infill well is added to the reservoir. The simulation opportunity index, in some implementations, represents a summary metric or a qualitative or quantitative metric that indicates potential optimal target locations to place an infill well. The simulation opportunity index, in some implementations, is computed as a linear combination of reservoir porosity data, horizontal permeability data, and mobile oil saturation data associated with the simulation model. The method, at block 412, marks an influence radius around a selected infill well location. The influence radius, according to some implementations includes a radius of about 400 meters (m), or a radius of about 500 m, or a radius of about 600 m, or a radius of about 650 m, or a radius of about 700 m from a central point associated with the selected infill well location. In some embodiments, the influence radius range is between 450 m-850 m. The computed reservoir properties and a binary reservoir property indicating potential infill well locations and their regions of influence are thereafter converted, at block 414, from an unstructured grid representation into a structured grid representation to form a multi-dimensional (e.g., 3-dimensional) tensor. The training data for the machine learning model, according to some embodiments, is represented by a multi-dimensional (e.g. 3-dimensional) tensor. The training data generation may be repeated for different random initial well placements and reservoir operating conditions for realization of multiple reservoir models.

### Machine Learning Model Training

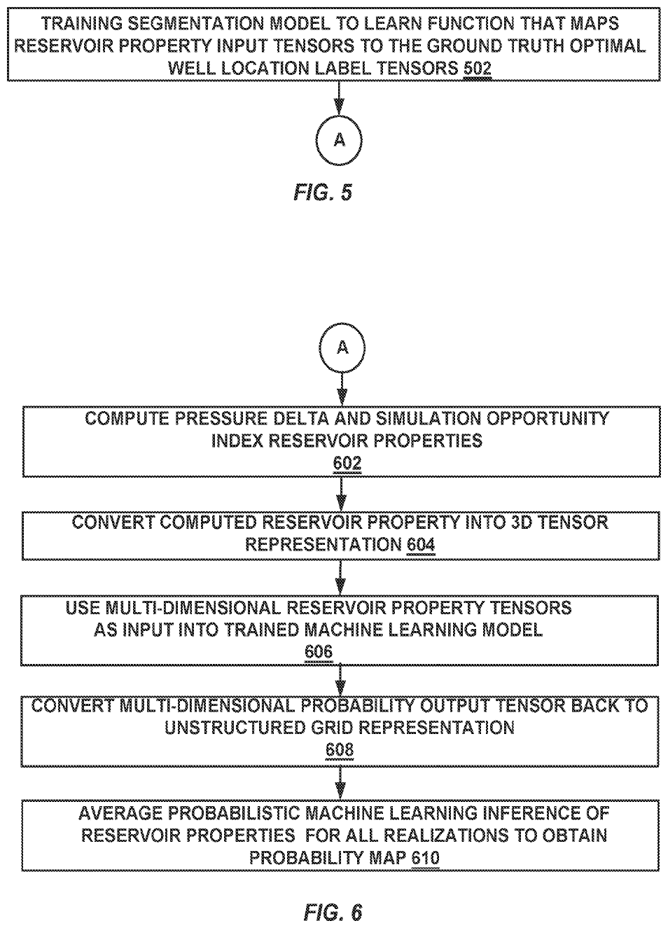

According to some embodiments, a machine learning model includes a multi-dimensional (e.g., a 3-dimensional) image segmentation model generated from a deep learning model/engine that produces an output having similar spatial parameters (e.g., dimensions) as its input. The multi-dimensional image segmentation model, according to one embodiment, is trained, at block 502 of FIG. 5, to learn or otherwise develop a function that maps reservoir property input tensors to ground truth optimal well location label tensors. According to some embodiments, the ground truth optimal well location label tensors include data associated with one or more optimal infill well locations of the reservoir that have been identified using the process of FIG. 4, for example. In some cases, the data associated with the ground truth optimal well location is used to train the reservoir model. The multi-dimensional image segmentation model, according to some embodiments, is a convolutional neural network model that takes as its input a pressure delta and a simulation opportunity index including tensors produced in the training data generation step of the workflow of FIG. 5. The well location tensors containing the optimal infill well locations are used, in some examples, as the ground truth labels. The multi-dimensional convolutional neural network, in some embodiments, is trained using a stochastic gradient descent technique that minimizes an error between the ground truth label and the probabilistic output of the convolutional neural network. The probabilistic output of the convolutional neural network, according to exemplary implementations, is between a value range of between 0-1 with higher numbers being indicative of a good infill target region, for example.

### Machine Learning Inference

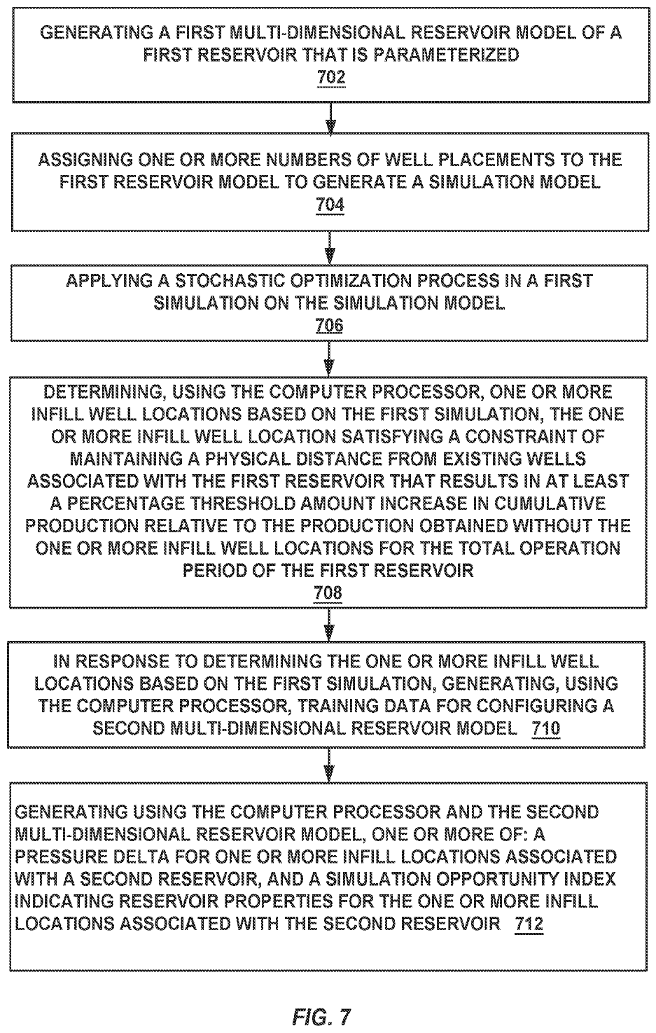

The inference generation stage, which is depicted in the flowchart of FIG. 6 allows prediction of optimal well locations for a particular time step using an ensemble of a reservoir simulation model. For each realization of the ensemble of the reservoir simulation model, the pressure delta and simulation opportunity index reservoir properties are computed at block 602 for a second well. In some embodiments, the opportunity index reservoir properties includes permeability data, porosity data, oil saturation data, gas saturation data, etc. for the second reservoir. The computed opportunity index reservoir properties are thereafter converted, at block 604, into a tensor representation (e.g., multi-dimensional reservoir property tensors) and used as input, at block 606, to the trained machine learning model. The probabilistic output tensor from the machine learning model, according to one embodiment, are converted back, at block 608, to a reservoir grid representation. In some embodiments, the trained machine learning model operates or otherwise ingests new data associated with the second reservoir (or another reservoir) and subsequently generates a reservoir grid representation indicating optimal infill well locations for the second reservoir. The optimal infill well locations may be identified or otherwise indicated using one or more indicators associated with the reservoir grid representation which can be visualized or otherwise displayed on a graphical user interface device such as a monitor, a touchscreen device, a tablet device, or a mobile device screen. In some embodiments, the reservoir grid representation includes a multi-dimensional (3-dimensional) map of the second reservoir with indicators pointing to the optimal infill well locations. According to one embodiment, the reservoir grid representation or the multi-dimensional map comprises a probability map that is generated, at block 610, by averaging probabilistic machine learning inferences of reservoir properties for all model realizations. This multi-dimensional map/the probability map may be used by one or more computer processors and/or by one or more computing applications to place (e.g., execute drilling operations) one or more wells at specific locations of the second reservoir for optimal production and for exploratory operations such as drilling, fracking, or other activities at the resource site within which the second reservoir is located.

The disclosed methods and systems beneficially allow quickly (e.g., real-time or near real-time) identification of optimal infill well placements in a mature reservoir. This enables well placement evaluations on a large ensemble of reservoir models using a machine learning model that approximates an optimization process to enable quick inferences and eliminates the need to make multiple calls to a physics-based simulator. The disclosed technology, for some examples, is applied in locating optimal infill well target locations in a mature reservoir by assigning a probability score to regions in the reservoir. Regions with high probability scores are, according to some embodiments, optimal locations for infill wells associated with the reservoir. The disclosed technology eliminates the need to use computation-intensive optimization processes that execute multiple calls to physics-based simulators during infill well placement workflows. The probabilistic output from the machine learning model may enable quantification of uncertainty during infill well placement. According to some embodiments, the disclosed technology enables a quick and statistically robust ensemble based well placement workflows. In particular, the disclosed technology provides the following benefits: quick inference for ensemble-based infill well placement workflows; eliminates the need for computation-intensive optimization processes and multiple calls to physics-based simulators; enables uncertainty quantification for locations identified as being optimal for infill well placement; enables spatially aware inferences to be made by using specific property fields across the entire reservoir as its input; and enables probability maps which characterize confidence data that indicate whether a particular region in a reservoir is a good infill well location.

FIG. 7 provides an exemplary workflow for methods, systems, and computer programs that place one or more optimal infill well locations within a reservoir. It is appreciated that a data managing module stored in a memory device may cause a computer processor to execute the various processing stages of FIG. 7. For example, the disclosed techniques may be implemented as a signal processing engine or a data manager within a geological software tool such that the signal processing engine enables the modeling of geological structures in the subsurface of a resource site based on the processes outlined herein.

At block 702, the signal processing engine may generate a first multi-dimensional reservoir model (simply called reservoir model) of a first reservoir that is parameterized. The signal processing engine may further assign, at block 704, one or more numbers of well placements (e.g., well placement data) to the first reservoir model to generate a simulation model. According to one embodiment, the signal processing engine may apply, at block 706, a stochastic optimization process in a first simulation on the simulation model. At block 708, the signal processing engine may determine one or more infill well locations (e.g., infill well locations data) based on the first simulation. The one or more infill well locations may satisfy a constraint of maintaining a physical distance from existing wells associated with the first reservoir that results in at least a percentage threshold amount increase in cumulative production relative to the production obtained without the one or more infill well locations for the total operation period of the first reservoir. In response to determining the one or more infill well locations (e.g., one or more infill well locations data) based on the first simulation, the signal processing engine may generate, at block 710, training data and/or configure a second multi-dimensional reservoir model associated with a second reservoir using the training data. It is appreciated that the training data, according to one embodiment, is generated using the one or more infill well locations data. In addition, the signal processing engine may generate using the second multi-dimensional reservoir model, at block 712, one or more of: a pressure delta (e.g., pressure delta data) for one or more infill locations associated with the second reservoir, and a simulation opportunity index (e.g., opportunity index data) indicating reservoir properties for the one or more infill locations associated with the second reservoir.

These and other implementations may each optionally include one or more of the following features. For example, the first multi-dimensional reservoir model may be generated based on a plurality of reservoirs including the first reservoir. Furthermore, the first multi-dimensional reservoir model of the first reservoir is parameterized using one or more of: data associated with a number of wells of the first reservoir; data associated with a number of grid cells of the first reservoir; data associated with an average permeability of the first reservoir; or data associated with a production duration history of the reservoir.

According to some embodiments, the number of well placements discussed in association with block 704 include: one or more producer wells indicating one or more wells associated with the first reservoir from which fluid is produced; or one or more injector wells indicating one or more wells associated with the first reservoir into which fluid is injected. Moreover, the stochastic optimization process discussed in association with block 706 may include one or more of: dynamically moving a target well around a plurality of locations associated with the first reservoir; and generating production data indicative of a predicted fluid production of the target well at the plurality of locations of the first reservoir. In addition, generating using the second multi-dimensional reservoir model, comprises one or more of: determining a pressure delta for one or more infill locations associated with a second reservoir; and generating a simulation opportunity index indicating reservoir properties for the one or more infill locations associated with the second reservoir in real-time or near real-time. According to some embodiments, generating using the second multi-dimensional reservoir model, comprises one or more of: determining a pressure delta for one or more infill locations associated with a second reservoir; and a simulation opportunity index indicating reservoir properties for the one or more infill locations associated with the second reservoir. Moreover, the disclosed process may further include initiating rendering of a multi-dimensional visualization including visual elements of at least the pressure delta or the simulation opportunity index such that the multi-dimensional visualization provides a map indicating one or more optimal infill well locations associated with the second reservoir. As previously discussed, the multi-dimensional visualization may facilitate energy development operations according to some embodiments. Such energy development operations may include automatically controlling fluid flow control devices associated with a well coupled to a reservoir, initiating drilling of specific locations at a resource site to access one or more reservoirs at the resource site, determining whether an energy exploration project is viable based on the multi-dimensional visualization, etc.

These systems, methods, processing procedures, techniques, and workflows increase effectiveness and efficiency. Such systems, methods, processing procedures, techniques, and workflows may complement or replace conventional methods for identifying, isolating, transforming, and/or processing various aspects of data that is collected from a subsurface region or other multi-dimensional space to enhance flow simulation prediction accuracy.

A benefit of the present disclosure is that more effective methods for downhole operations may be employed. It is appreciated that the applications and benefits of the disclosed techniques are not limited to subterranean wells and reservoirs and may also be applied to other types of energy explorations and/or other resource explorations (e.g., aquifers, Lithium/Salar brines, etc.).

While any discussion of or citation to related art in this disclosure may or may not include some prior art references, Applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to use the invention and various embodiments with various modifications as are suited to the particular use contemplated.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for placing one or more optimal infill well locations within a reservoir, the method comprising:
generating, using a computer processor, a first multi-dimensional reservoir model of a first reservoir that is parameterized;
assigning, using the computer processor, one or more numbers of well placements to the first reservoir model to generate a simulation model;
applying, using the computer processor, a stochastic optimization process in a first simulation on the simulation model;
determining, using the computer processor, one or more infill well locations based on the first simulation, the one or more infill well location satisfying a constraint of maintaining a physical distance from existing wells associated with the first reservoir that results in at least a percentage threshold amount increase in cumulative production relative to the production obtained without the one or more infill well locations for the total operation period of the first reservoir;
in response to determining the one or more infill well locations based on the first simulation, generating, using the computer processor, training data for configuring a second multi-dimensional reservoir model; and
generating using the computer processor and the second multi-dimensional reservoir model, one or more of:
a pressure delta for one or more infill locations associated with a second reservoir, and
a simulation opportunity index indicating reservoir properties for the one or more infill locations associated with the second reservoir.

2. The method of claim 1, wherein the first multi-dimensional reservoir model is based on a plurality of reservoirs including the first reservoir.

3. The method of claim 1, wherein the first multi-dimensional reservoir model of the first reservoir is parameterized using one or more of:
data associated with a number of wells of the first reservoir;
data associated with a number of grid cells of the first reservoir;
data associated with an average permeability of the first reservoir; or
data associated with a production duration history of the reservoir.

4. The method of claim 1, wherein the number of well placements include:
one or more producers indicating one or more wells associated with the first reservoir from which fluid is produced; or
one or more injectors indicating one or more wells associated with the first reservoir into which fluid is injected.

5. The method of claim 1, wherein the stochastic optimization process including:
dynamically moving a target well around a plurality of locations associated with the first reservoir; and
generating production data indicative of a predicted production of the target well at the plurality of locations of the first reservoir.

6. The method of claim 1, wherein generating using the computer processor and the second multi-dimensional reservoir model, includes one or more of:
determining a pressure delta for one or more infill locations associated with the second reservoir; and
generating, based on the pressure delta, a simulation opportunity index indicating reservoir properties for the one or more infill locations associated with the second reservoir is in real-time or near real-time.

7. The method of claim 1, wherein generating using the computer processor and the second multi-dimensional reservoir model, includes one or more of:
a pressure delta for one or more infill locations associated with the second reservoir; and
a simulation opportunity index indicating reservoir properties for the one or more infill locations associated with the second reservoir.

8. The method of claim 1, comprising initiating, using the computer processor, rendering of a multi-dimensional visualization including visual elements of at least the pressure delta or the simulation opportunity index, the multi-dimensional visualization providing a map indicating one or more optimal infill well locations associated with the second reservoir.

9. A system for placing one or more optimal infill well locations within a reservoir, the system comprising:
a computer processor, and
memory storing a data processing engine that includes instructions which are executable by the computer processor to:
generate a first multi-dimensional reservoir model of a first reservoir that is parameterized;
assign one or more numbers of well placements to the first reservoir model to generate a simulation model;
apply a stochastic optimization process in a first simulation on the simulation model;
determine one or more infill well locations based on the first simulation, the one or more infill well location satisfying a constraint of maintaining a physical distance from existing wells associated with the first reservoir that results in at least a percentage threshold amount increase in cumulative production relative to the production obtained without the one or more infill well locations for the total operation period of the first reservoir;
in response to determining the one or more infill well locations based on the first simulation, generate training data for configuring a second multi-dimensional reservoir model; and
generate using the second multi-dimensional reservoir model, one or more of:
a pressure delta for one or more infill locations associated with a second reservoir, and
a simulation opportunity index indicating reservoir properties for the one or more infill locations associated with the second reservoir.

10. The system of claim 9, wherein the first multi-dimensional reservoir model is based on a plurality of reservoirs including the first reservoir.

11. The system of claim 9, wherein the first multi-dimensional reservoir model of the first reservoir is parameterized using one or more of:
data associated with a number of wells of the first reservoir;
data associated with a number of grid cells of the first reservoir;
data associated with an average permeability of the first reservoir; or
data associated with a production duration history of the reservoir.

12. The system of claim 9, wherein the number of well placements include:
one or more producers indicating one or more wells associated with the first reservoir from which fluid is produced; or
one or more injectors indicating one or more wells associated with the first reservoir into which fluid is injected.

13. The system of claim 9, wherein the stochastic optimization process including:
dynamically moving a target well around a plurality of locations associated with the first reservoir; and
generating production data indicative of a predicted production of the target well at the plurality of locations of the first reservoir.

14. The system of claim 9, wherein generating using the second multi-dimensional reservoir model, includes one or more of:
determining a pressure delta for one or more infill locations associated with the second reservoir; and
generating, based on the pressure delta, a simulation opportunity index indicating reservoir properties for the one or more infill locations associated with the second reservoir is in real-time or near real-time.

15. The system of claim 9, wherein generating the second multi-dimensional reservoir model, includes one or more of:
a pressure delta for one or more infill locations associated with the second reservoir; and
a simulation opportunity index indicating reservoir properties for the one or more infill locations associated with the second reservoir.

16. The system of claim 9, wherein the instructions further cause the computer processor to initiate rendering of a multi-dimensional visualization including visual elements of at least the pressure delta or the simulation opportunity index, the multi-dimensional visualization providing a map indicating one or more optimal infill well locations associated with the second reservoir.

17. A computer program for placing one or more optimal infill well locations within a reservoir, the computer program comprising a non-transitory computer-readable medium comprising code configured to:
generate a first multi-dimensional reservoir model of a first reservoir that is parameterized;
assign one or more numbers of well placements to the first reservoir model to generate a simulation model;
apply a stochastic optimization process in a first simulation on the simulation model;
determine one or more infill well locations based on the first simulation, the one or more infill well location satisfying a constraint of maintaining a physical distance from existing wells associated with the first reservoir that results in at least a percentage threshold amount increase in cumulative production relative to the production obtained without the one or more infill well locations for the total operation period of the first reservoir;
in response to determining the one or more infill well locations based on the first simulation, generate training data for configuring a second multi-dimensional reservoir model; and
generate using the second multi-dimensional reservoir model, one or more of:
a pressure delta for one or more infill locations associated with a second reservoir, and
a simulation opportunity index indicating reservoir properties for the one or more infill locations associated with the second reservoir.

18. The computer program of claim 17, wherein the number of well placements include:
one or more producers indicating one or more wells associated with the first reservoir from which fluid is produced; or
one or more injectors indicating one or more wells associated with the first reservoir into which fluid is injected.

19. The computer program of claim 17, wherein the stochastic optimization process including:
dynamically moving a target well around a plurality of locations associated with the first reservoir; and
generating production data indicative of a predicted production of the target well at the plurality of locations of the first reservoir.

20. The computer program of claim 17, wherein the instructions further cause the computer processor to initiate rendering of a multi-dimensional visualization including visual elements of at least the pressure delta or the simulation opportunity index, the multi-dimensional visualization providing a map indicating one or more optimal infill well locations associated with the second reservoir.
